(19) United States
(12) Patent Application Publication
(10) Pub. No.: US 2013/0161170 A1
(43) Pub. Date: Jun. 27, 2013

(54) KEYBOARD DEVICE WITH LUMINOUS KEY

(71) Applicants: Shu-Jian Fan, Taipei (TW); Hsiang-Wen Cheng, Taipei (TW)

(72) Inventors: Shu-Jian Fan, Taipei (TW); Hsiang-Wen Cheng, Taipei (TW)

(73) Assignee: PRIMAX ELECTRONICS LTD., Taipei (TW)

(21) Appl. No.: 13/425,158

(22) Filed: Mar. 20, 2012

(30) Foreign Application Priority Data
Dec. 21, 2011 (CN) 201110431570.2

(51) Int. Cl. H01H 13/76

(52) U.S. Cl. 200/5 A

(57) ABSTRACT

A keyboard device includes at least one luminous key, at least one light-emitting element, a membrane switch circuit member, an opaque seal structure, and a transparent seal structure. The luminous key has a light-transmissible zone. The light-emitting element is electrically connected with the membrane switch circuit member, and disposed under the light-transmissible zone. A top surface of the light-emitting element is encapsulated by the transparent seal structure. The transparent seal structure is partially surrounded by the opaque seal structure. Consequently, the light beam from the light-emitting element is transmissible through the transparent seal structure, and directed to the light-transmissible zone.

### FIELD OF THE INVENTION

The present invention relates to a keyboard device, and more particularly to a keyboard device with a luminous key.

### BACKGROUND OF THE INVENTION

Generally, the common input device of a computer system includes for example a mouse, a keyboard device, a trackball, or the like. Via the keyboard device, the user may input characters and commands into the computer system. As a consequence, most users and most manufacturers pay much attention to the development of keyboard devices.

Hereinafter, the configurations and functions of a conventional keyboard device will be illustrated with reference to FIG. 1. FIG. 1 is a schematic view illustrating the outward appearance of a conventional keyboard device. The surface of the conventional keyboard device 1 includes plural keys 10 and plural indicating lamps 11. These keys 10 include ordinary keys, numeric keys, function keys, and the like. When one or more keys are pressed by the user, a corresponding signal is issued to the computer, and thus the computer executes a function corresponding to the pressed key or keys. For example, when an ordinary key is depressed, a corresponding English letter or symbol is inputted into the computer. When a numeric key is depressed, a corresponding number is inputted into the computer. In addition, the function keys (F1˜F12) can be programmed to cause corresponding application programs to provide certain functions. The locations of the indicating lamps 11 correspond to the Caps lock key, the Number lock key and the Scroll lock key, respectively. In a case that one of the Caps lock key, the Number lock key and the Scroll lock key is depressed, a corresponding specific function is enabled, and thus a corresponding indicating lamp 11 is turned on to result in a prompt. According to the illuminated indicating lamp, the user may realize that the corresponding one of the Caps lock key, the Number lock key and the Scroll lock key is depressed and the corresponding function is enabled. Since these indicating lamps 11 occupy additional layout space of the keyboard, the indicating lamps become hindrance from miniaturization of the keyboard device. Moreover, too many indicating lamps 11 may confuse the user. Under this circumstance, the user fails to accurately judge which key correlates to the illuminated indicating lamp.

For solving the above drawbacks, a keyboard device with a luminous key as shown in FIGS. 2 and 3 is disclosed. FIG. 2 is a schematic cross-sectional view illustrating a conventional keyboard device with a luminous key. FIG. 3 is a schematic enlarged fragmentary view illustrating the keyboard device of FIG. 2. The keyboard device 2 comprises a base 20, plural luminous keys 21, plural non-luminous keys 22, plural light-emitting elements 23, a membrane switch circuit member 24, and a plastic film layer 25. Each of the luminous keys 21 comprises a keycap 211 and an elastic element 212. Each of the non-luminous keys 22 comprises a keycap 221 and an elastic element 222. The keycap 211 of each luminous key 21 has a light-transmissible zone 2111. The plural light-emitting elements 23 are disposed on the membrane switch circuit member 24 and arranged under the transparent portions 2111 of corresponding luminous keys 21. The plural light-emitting elements 23 are used for generating plural light beams (not shown), which may be transmitted through the transparent portions 2111 of the luminous keys 21. The luminous keys 21 are specified function keys, which may be triggered to enable specified functions. For example, the luminous keys 21 are Caps lock key, the Number lock key and the Scroll lock key. Each of the luminous keys 21 further comprises a light shade 213 with an opening 2131. In addition, the corresponding light-emitting element 23 is enclosed by the light shade 213. Consequently, the light beams emitted by the light-emitting element 23 are only permitted to be transmitted through the opening 2131 of the light shade 213 without being scattered to the periphery of the light shade 213. As shown in FIGS. 2 and 3, the light-emitting elements 23 are top-view light emitting diodes. In addition, the light shade 213 is made of a rubbery material.

The membrane switch circuit member 24 comprises an upper wiring board 241, a partition plate 242, and a lower wiring board 243. The upper wiring board 241 has plural upper contacts 2411 corresponding to the plural luminous keys 21 and the plural non-luminous keys 22. The partition plate 242 is disposed under the upper wiring board 241. In addition, the partition plate 242 has plural perforations 2421 corresponding to the plural upper contacts 2411. The lower wiring board 243 is disposed under the partition plate 242. In addition, the lower wiring board 243 has plural lower contacts 2431 corresponding to the plural perforations 2421. Each of the upper contacts 2411, the corresponding perforation 2421 and the corresponding lower contact 2431 are collectively defined as a membrane switch 244. The plastic film layer 25 is disposed on the membrane switch circuit member 24. In addition, the plastic film layer 25 is coated with black ink 251, so that the light beams are blocked by the plastic film layer 25. The base 20 is used for supporting the plural luminous keys 21, the plural non-luminous keys 22, the plural light-emitting elements 23, the membrane switch circuit member 24 and the plastic film layer 25.

When one of the keycap 211 and 221 of the keys 21 and 22 is depressed, the keycap 211 or 221 is moved downwardly to compress the elastic element 212 or 222, so that the elastic element 212 or 222 is sustained against the corresponding upper contact 2411. Consequently, the upper contact 2411 is inserted into the corresponding perforation 2421 to be contacted with the corresponding lower contact 2431. When the upper contact 2411 and the lower contact 2431 are contacted with each other, the corresponding membrane switch 244 is electrically conducted, and thus a corresponding luminous key signal or a corresponding non-luminous key signal is generated. On the other hand, when the depressing force exerted on the keycap 211 or 221 is eliminated, an elastic force provided by the elastic element 212 or 222 is acted on the keycap 211 or 221, so that the elastic element 212 or 222 is moved upwardly and returned to an original position.

In addition, when the keycap 211 of one of the luminous keys 21 is depressed and a luminous key signal is generated, the specified function corresponding to the depressed luminous key 21 is enabled. In addition, a corresponding light-emitting element 23 is driven to emit a light beam in response to the luminous key signal. The light beam will be sequentially transmitted through the opening 2131 of the light shade 213 and the light-transmissible zone 2111 of the keycap 211. Since the light shade 213 has a function of converging the light beam, the intensity of the light beam emerged from the light-transmissible zone 2111 of the keycap 211 is increased to facilitate the user to realize whether the specified function corresponding to the depressed luminous key 21 is enabled.

Since the light shades 213 of the luminous keys 21 are attached on the plastic film layer 25 by adhesion, some drawbacks of the keyboard device 2 may possibly occur. For example, during the process of attaching the light shade 213 on the plastic film layer 25, if the light shade 213 is suffered from misalignment, the opening 2131 of the light shade 213 fails to be aligned with the light-emitting element 23. Under this circumstance, only a portion of the light beam from the light-emitting element 23 is transmissible through the opening 2131 of the light shade 213. Whereas, the remaindering portion of the light beam from the light-emitting element 23 is blocked by the light shade 213. Consequently, the luminous efficacy of the luminous key 21 is insufficient for the user to identify whether the luminous key 21 is illuminated. In addition, an assembling error is readily generated during the process of assembling the light shade 213 and the plastic film layer 25. Consequently, after the keyboard 2 is produced, the light shade 213 is easily detached. Under this circumstance, the intensity of the light beam emerged from the light-transmissible zone 2211 of the keycap 221 is usually insufficient. Once the light shade 213 is detached, the light beam emitted by the light-emitting element 23 will be scattered everywhere because the light beam is no longer converged by the light shade 213. Under this circumstance, the luminous efficacy of the luminous key 21 is still insufficient.

Moreover, since the light shade 213 is made of a rubbery material, the light shade 213 has at least a certain thickness T according to the current technology of processing the rubbery material. In addition, there is a distance D between the bottom surface of the keycap 211 and the top surface of the light shade 213. When the keycap 211 of the luminous key 21 is depressed and the keycap 211 is moved downwardly for the distance D, the bottom surface of the keycap 211 will be contacted with the top surface of the light shade 213. Under this circumstance, the light shade 213 becomes hindrance from continuously depressing the keycap 211. For making electrical conduction of the membrane switch 244, the depressing force acted on the keycap 211 should be increased to move the light shade 213 and the elastic element 212 downwardly. In other words, during the process of depressing the keycap 211, the movement of the keycap 211 is readily interfered by the light shade 213, and thus the operating feel is usually unsatisfied.

Therefore, there is a need of providing a keyboard device with a luminous key and with enhanced operating feel.

### SUMMARY OF THE INVENTION

The present invention provides a keyboard device with a luminous key and with enhanced operating feel.

In accordance with an aspect of the present invention, there is provided a keyboard device. The keyboard device includes a membrane switch circuit member, at least one luminous key, and at least one light-emitting element. When the membrane switch circuit member is triggered, a luminous key signal is generated. The at least one luminous key is disposed on the membrane switch circuit member. When the at least one luminous key is depressed, the membrane switch circuit member is triggered. In addition, the at least one luminous key has a light-transmissible zone. The at least one light-emitting element is electrically connected with the membrane switch circuit member and disposed under the light-transmissible zone. The at least one light-emitting element emits a light beam in response to the luminous key signal. A light-emitting region of the at least one light-emitting element is encapsulated by a transparent seal structure, and the transparent seal structure is surrounded by an opaque seal structure, so that a light-outputting region of the transparent seal structure is exposed outside the opaque seal structure. The light beam is emitted by the light-emitting region, transmitted through the transparent seal structure, and directed to the light-transmissible zone through the light-outputting region.

In an embodiment, the transparent seal structure is surrounded by an opaque seal structure, and a top surface of the transparent seal structure is partially sheltered by the opaque seal structure, so that a light-outputting region at the top surface of the transparent seal structure is exposed outside the opaque seal structure. The light beam is blocked by the opaque seal structure, so that a possibility of scattering the light beam is reduced.

In an embodiment, the transparent seal structure is made of transparent epoxy resin, and the opaque seal structure is made of opaque epoxy resin, wherein the opaque epoxy resin is produced by mixing transparent epoxy resin with a dying agent.

In an embodiment, the transparent seal structure further contains phosphor powder, and the phosphor powder is distributed within the transparent seal structure, so that the transparent seal structure has a first color. If the light beam has a second color, the light beam outputted from the transparent seal structure has a third color, wherein the third color is a mixed color of the first color and the second color.

In an embodiment, after the opaque seal structure is disposed on the at least one light-emitting element, the transparent seal structure is filled into a space between the opaque seal structure and the at least one light-emitting element, so that the at least one light-emitting element is encapsulated by the transparent seal structure.

In an embodiment, the keyboard device further includes a non-luminous key, which is disposed on the membrane switch circuit member. When the membrane switch circuit member is depressed, a corresponding non-luminous key signal is generated.

In an embodiment, the membrane switch circuit member includes an upper wiring board, a partition plate, and a lower wiring board. The upper wiring board has at least one upper contact corresponding to the at least one luminous key or the at least one non-luminous key. The partition plate is disposed under the upper wiring board, and has at least one perforation corresponding to the at least one upper contact. When the membrane switch circuit member is depressed, the at least one upper contact is inserted into the at least one perforation. The lower wiring board is disposed under the partition plate, and has at least one lower contact corresponding to the at least one upper contact. The at least one upper contact, the at least one perforation and the at least one lower contact are collectively defined at least one membrane switch. When the membrane switch circuit member is depressed, the at least one lower contact and the at least one upper contact are contacted with each other, so that the luminous key signal or the non-luminous key signal is generated.

In an embodiment, the keyboard device further includes a bottom plate for supporting the at least one non-luminous key and the at least one luminous key. The at least one luminous key includes a keycap, a scissors-type connecting element, and an elastic element. The keycap is exposed to a top surface of the keyboard device, wherein the light-transmissible zone is included in the keycap. The scissors-type connecting element is arranged between the bottom plate and the keycap for connecting the bottom plate and the keycap, and allowing the keycap to be moved upwardly and downwardly relative to the bottom plate. The elastic element is arranged between the membrane switch circuit member and the keycap. When the keycap is depressed, the elastic element is compressed and sustained against the membrane switch circuit module, so that the membrane switch circuit member generates the luminous key signal. When a depressing force exerted on the key is eliminated, an elastic force provided by the elastic element is acted on the keycap, so that the keycap is returned to an original position.

In an embodiment, the keyboard device further includes a base for supporting the at least one non-luminous key and the at least one luminous key. The at least one luminous key includes a keycap, a key housing, and an elastic element. The keycap is exposed to a top surface of the keyboard device, wherein the light-transmissible zone is included in the keycap. The key housing is arranged between the base and the keycap for supporting the keycap. The elastic element is penetrated through the key housing and arranged between the membrane switch circuit member and the keycap. When the keycap is depressed, the elastic element is compressed and sustained against the membrane switch circuit module, so that the membrane switch circuit member generates the luminous key signal. When a depressing force exerted on the key is eliminated, an elastic force provided by the elastic element is acted on the keycap, so that the keycap is returned to an original position.

In an embodiment, the at least one light-emitting element further includes a light-emitting circuit board and a light-emitting chip. The light-emitting circuit board is electrically connected with the membrane switch circuit member. The light-emitting chip is disposed on the light-emitting circuit board and electrically connected with the light-emitting circuit board for generating the light beam. In addition, the at least one light-emitting element is a top-view light emitting diode.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the outward appearance of a conventional keyboard device;

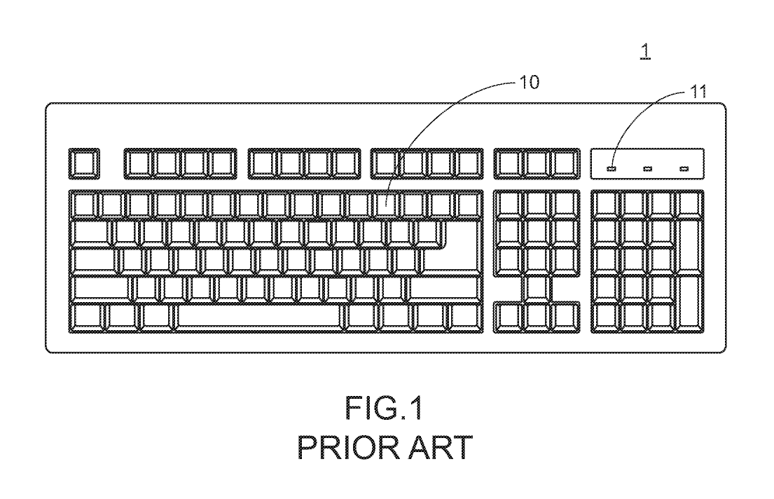

FIG. 2 is a schematic cross-sectional view illustrating a conventional keyboard device with a luminous key;

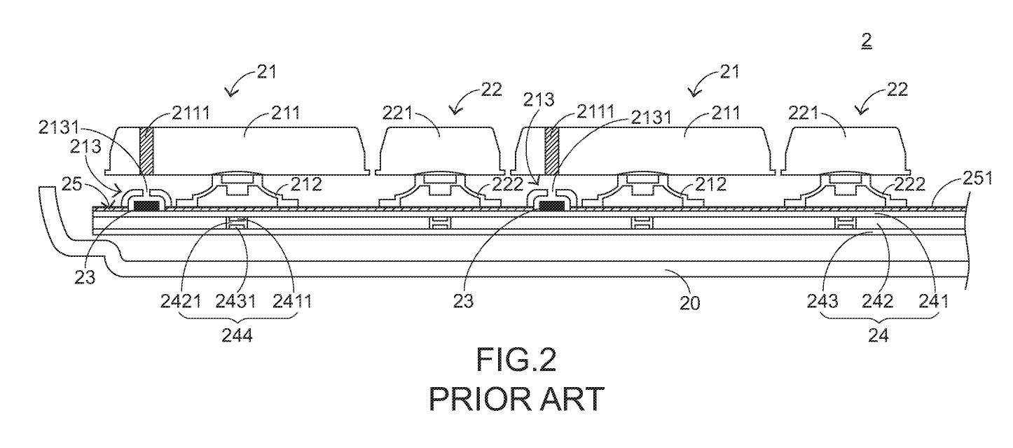

FIG. 3 is a schematic enlarged fragmentary view illustrating the keyboard device of FIG. 2;

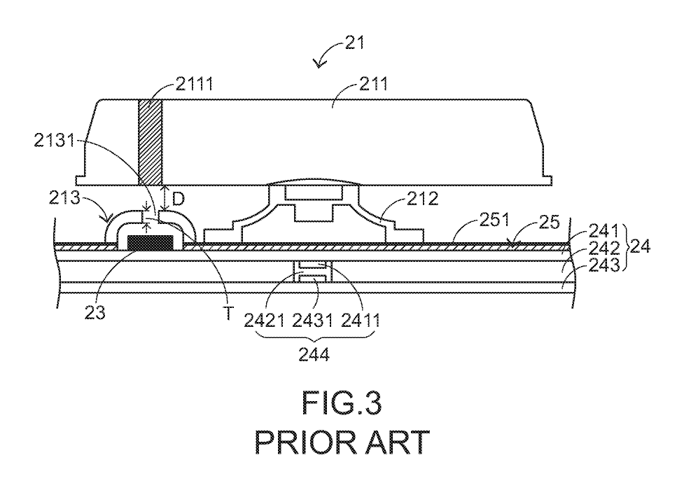

FIG. 4 is a schematic cross-sectional view illustrating a keyboard device with a luminous key according to an embodiment of the present invention;

FIG. 5 is a schematic enlarged fragmentary view illustrating the keyboard device of FIG. 4;

FIGS. 6A-6E schematically illustrate a process of assembling the keyboard device according to an embodiment of the present invention; and

FIG. 7 is a schematic cross-sectional view illustrating a keyboard device with a luminous key according to another embodiment of the present invention

### DETAILED DESCRIPTION OF THE PREFERRED EMBODIMENT

For obviating the drawbacks encountered from the prior art, the present invention provides a keyboard device with a luminous key and with enhanced operating feel.

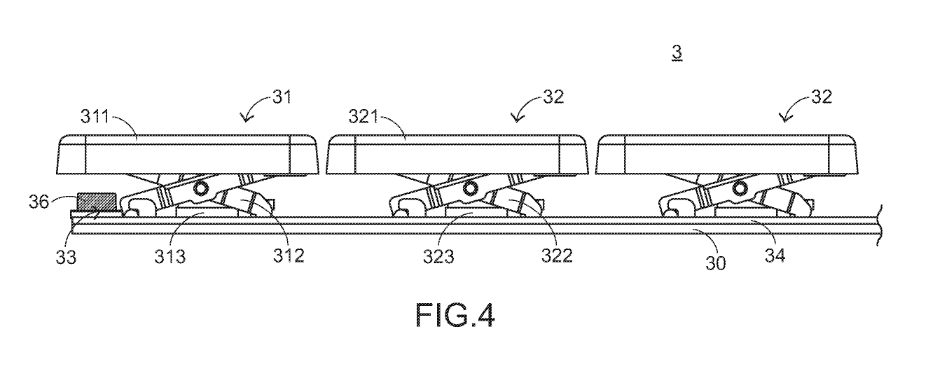

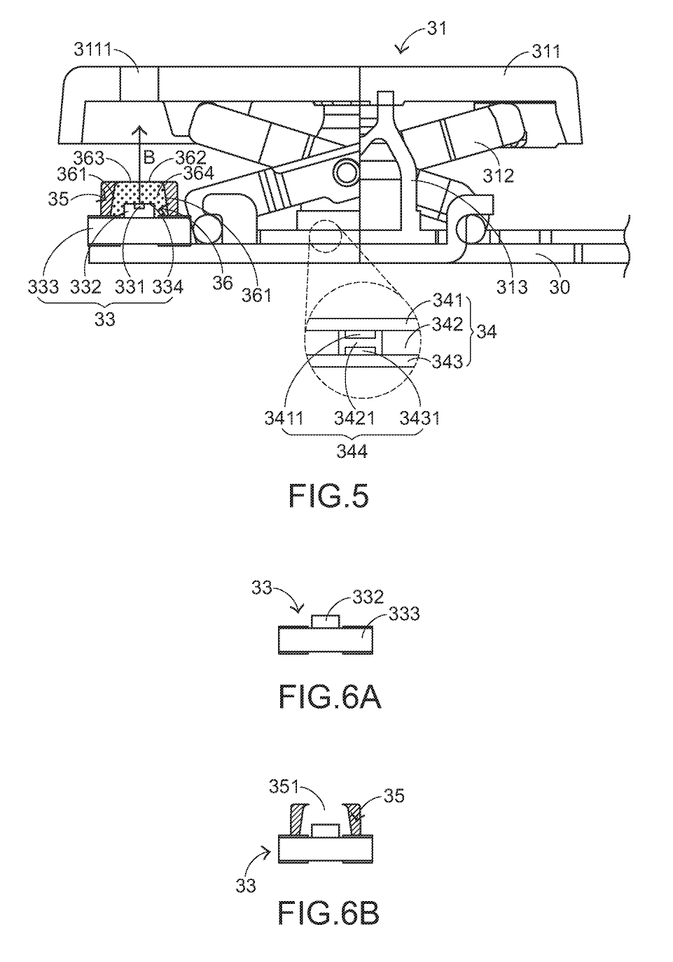

FIG. 4 is a schematic cross-sectional view illustrating a keyboard device with a luminous key according to an embodiment of the present invention. FIG. 5 is a schematic enlarged fragmentary view illustrating the keyboard device of FIG. 4. Please refer to FIGS. 4 and 5. The keyboard device 3 comprises a bottom plate 30, at least one luminous key 31, plural non-luminous keys 32, plural light-emitting elements 33, a membrane switch circuit member 34, an opaque seal structure 35, and a transparent seal structure 36. The bottom plate 30 is disposed under the membrane switch circuit member 34 for supporting the at least one luminous key 31, the plural non-luminous keys 32, the plural light-emitting elements 33 and the membrane switch circuit member 34.

Please refer to FIG. 4. The at least one luminous key 31 and the plural non-luminous keys 32 are disposed on the membrane switch circuit member 34. When the at least one luminous key 31 is depressed, the membrane switch circuit member 34 is triggered to generate a corresponding luminous key signal. When one of the plural non-luminous keys 32 is depressed, the membrane switch circuit member 34 is triggered to generate a corresponding non-luminous key signal. The luminous key 31 comprises a keycap 311, a scissors-type connecting element 312, and an elastic element 313. Each of the non-luminous keys 32 comprises a keycap 321, a scissors-type connecting element 322, and an elastic element 323. The keycaps 311 and 321 are exposed to a top surface of the keyboard device 3 to be depressed by the user. The keycap 311 of the luminous key 31 has a light-transmissible zone 3111. The scissors-type connecting element 312 (or 322) is arranged between the bottom plate 30 and the keycap 311 (or 321). The scissors-type connecting element 312 (or 322) is used for connecting the bottom plate 30 and the keycap 311 (321), and allowing the keycap 311 (or 321) to be moved upwardly and downwardly relative to the bottom plate 30. The elastic element 313 (or 323) is arranged between the membrane switch circuit member 34 and the keycap 311 (or 321). When one of the keycap 311 and 321 of the keys 31 and 32 is pressed, the keycap 311 or 321 is moved downwardly to compress the elastic element 312 or 322, so that the elastic element 312 or 322 is sustained against the membrane switch circuit member 34. Consequently, the membrane switch circuit member 34 generates a corresponding luminous key signal or a corresponding non-luminous key signal. On the other hand, when the depressing force exerted on the keycap 311 or 321 is eliminated, an elastic force provided by the elastic element 312 or 322 is acted on the keycap 311 or 321, so that the elastic element 312 or 322 is moved upwardly and returned to an original position. The operating principles of the other components of the keyboard device 3 are similar to those of the conventional keyboard device 2, and are not redundantly described herein.

The membrane switch circuit member 34 is arranged between the bottom plate 30 and the at least one luminous key 31 and the plural non-luminous keys 32. Once the membrane switch circuit member 34 is triggered, a corresponding luminous key signal or a corresponding non-luminous key signal is generated. In this embodiment, the membrane switch circuit member 34 comprises an upper wiring board 341, a partition plate 342, and a lower wiring board 343. The upper wiring board 341 has plural upper contacts 3411 corresponding to the at least one luminous key 31 and the plural non-luminous keys 32. The partition plate 342 is disposed under the upper wiring board 341. In addition, the partition plate 342 has plural perforations 3421 corresponding to the plural upper contacts 3411. Once the membrane switch circuit member 34 is pushed by the elastic element 313 or 323, the corresponding upper contact 3411 is inserted into the corresponding perforation 3421. The lower wiring board 343 is disposed under the partition plate 342. In addition, the lower wiring board 343 has plural lower contacts 3431 corresponding to the plural upper contacts 3411. Each of the upper contacts 3411, the corresponding perforation 3421 and the corresponding lower contact 3431 are collectively defined as a membrane switch 344. When the membrane switch circuit member 34 is depressed, the corresponding lower contact 3431 and the corresponding upper contact 3411 are contacted with each other, and thus a corresponding luminous key signal or a corresponding non-luminous key signal is generated.

The plural light-emitting elements 33 of the keyboard device 3 are electrically connected with the membrane switch circuit member 34, and disposed under the light-transmissible zone 3111 of the at least one luminous key 31. In response to the luminous key signal, the plural light-emitting elements 33 emit a light beam B. In this embodiment, the light-emitting elements 33 are top-view light emitting diodes.

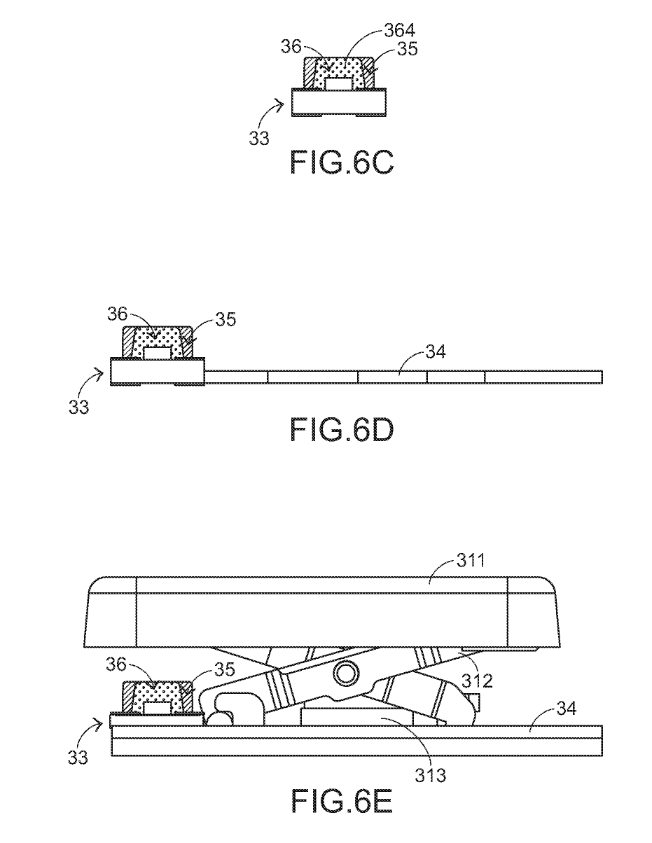

Please refer to FIG. 5. Each of the plural light-emitting elements 33 comprises a light-emitting region 331, a light-emitting chip 332, and a light-emitting circuit board 333. The light-emitting chip 332 is disposed on the light-emitting circuit board 333, and fixed on the light-emitting circuit board 333 by welding means. The light-emitting chip 332 is used for emitting the light beam B. The light-emitting chip 332 is electrically connected with the light-emitting circuit board 333 through a conductive wire (not shown). The light-emitting circuit board 333 is electrically connected with the membrane switch circuit member 34. The light-emitting region 331 is disposed on a top surface 334 of the light-emitting element 33 for emitting the light beam B. The light-emitting region 331 of the light-emitting element 33 is encapsulated by the transparent seal structure 36, and the light beam B is transmissible through the transparent seal structure 36. The transparent seal structure 36 is surrounded by the opaque seal structure 35. That is, an outer region 361 of the transparent seal structure 36 is surrounded by the opaque seal structure 35, so that an encapsulation cavity 351 is defined within the opaque seal structure 35 (see FIG. 6B). A top surface 362 of the transparent seal structure 36 is partially sheltered by the opaque seal structure 35. Consequently, the light-emitting element 33 is protected by the transparent seal structure 36 without being exposed outside. In addition, a light-outputting region 363 of the transparent seal structure 36 is exposed outside the opaque seal structure 35. The light-outputting region 363 is located at the top surface 362 of the transparent seal structure 36, and aligned with the encapsulation cavity 351. In such configurations, the light beam B is emitted by the light-emitting region 331 of the light-emitting element 33, and sequentially transmitted through the transparent seal structure 36, the light-outputting region 363 and the encapsulation cavity 351. Then, the light beam B is directed to the light-transmissible zone 3111 of the luminous key 31 to illuminate the luminous key 31. On the other hand, since the light beam B is not transmitted through the opaque seal structure 35 and blocked by the opaque seal structure 35, the opaque seal structure 35 surrounding the transparent seal structure 36 can block the light beam B and avoid scattering the light beam B.

Moreover, the transparent seal structure 36 further contains phosphor powder 364, which is distributed within the transparent seal structure 36. Due to the phosphor powder, the transparent seal structure 36 has a first color. In a case that the light beam B from the light-emitting element 33 has a second color, the light beam B outputted from the transparent seal structure 36 has a third color. The third color is a mixed color of the first color and the second color. For example, the transparent seal structure 36 has a yellow color, and the light beam B from the light-emitting element 33 has a blue color. Consequently, the light beam B outputted from the transparent seal structure 36 has a mixed color of the blue color and the white color. That is, the light beam B outputted from the transparent seal structure 36 has a white color. In this embodiment, the transparent seal structure 36 is made of transparent epoxy resin. The opaque seal structure 35 is made of opaque epoxy resin, wherein the opaque epoxy resin is produced by mixing transparent epoxy resin with a dying agent.

Hereinafter, a process of assembling the keyboard device 3 will be illustrated with reference to FIGS. 6A˜6E. Firstly, a light-emitting element 33 is provided and assembled. The light-emitting element 33 comprises a light-emitting region 331, a light-emitting chip 332, and a light-emitting circuit board 333. The light-emitting chip 332 is welded on the light-emitting circuit board 333. The light-emitting chip 332 is electrically connected with the light-emitting circuit board 333 through a conductive wire (not shown). Then, as shown in FIG. 6B, the opaque seal structure 35 is disposed on a top surface 334 of the light-emitting element 33, wherein an encapsulation cavity 351 is defined within the opaque seal structure 35. Then, as shown in FIG. 6C, transparent epoxy resin is filled into the encapsulation cavity 351 of the opaque seal structure 35. Consequently, a transparent seal structure 36 is formed on the top surface 334 of the light-emitting element 33, the light-emitting region 331 of the light-emitting element 33 is encapsulated by the transparent seal structure 36, the light-emitting region 331 is aligned with a light-outputting region 363 of the transparent seal structure 36, and the light-outputting region 363 of the transparent seal structure 36 is aligned with the encapsulation cavity 351. Then, as shown in FIG. 6D, the electrical connection between the light-emitting element 33 and the membrane switch circuit member 34 is established. Then, as shown in FIG. 6E, the membrane switch circuit member 34 is placed on the bottom plate 30, the elastic element 313 is disposed on the membrane switch circuit member 34, and the scissors-type connecting element 312 is connected with the bottom plate 30 and the keycap 311, wherein the light-transmissible zone 3111 of the keycap 311 is aligned with the encapsulation cavity 351 of the opaque seal structure 35.

In this embodiment, the light-emitting element 33 is located at a side of the membrane switch circuit member 34. In some embodiments, plural light-emitting elements are adhered on the upper wiring board, the partition plate and the lower wiring board of the membrane switch circuit member. Since the plural light-emitting elements are integrated into the membrane switch circuit member, the process assembling the keyboard device is simplified.

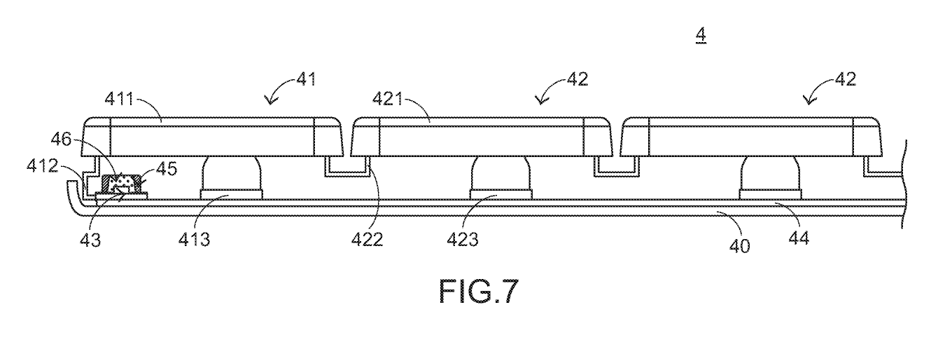

The present invention further provides a keyboard device of another embodiment. FIG. 7 is a schematic cross-sectional view illustrating a keyboard device with a luminous key according to another embodiment of the present invention. The keyboard device 4 comprises a base 40, at least one luminous key 41, plural non-luminous keys 42, plural light-emitting elements 43, a membrane switch circuit member 44, an opaque seal structure 45, and a transparent seal structure 46. Except for the following two items, the configurations of the keyboard device 4 are substantially identical to those of the keyboard device 3. Firstly, the at least one luminous key 41, the plural non-luminous keys 42, the plural light-emitting elements 43 and the membrane switch circuit member 44 are supported by the base 40. Secondly, the configurations of the luminous key 41 and the non-luminous keys 42 are varied according to the configuration of the base 40. The luminous key 41 comprises a keycap 411, a key housing 412, and an elastic element 413. Each of the non-luminous keys 42 comprises a keycap 421, a key housing 422, and an elastic element 423. The key housing 412 is arranged between the base 40 and the keycap 411 for supporting the keycap 411. The key housing 422 is arranged between the base 40 and the keycap 421 for supporting the keycap 421. The other components of the keyboard device 4 are similar to those of the keyboard device 4, and are not redundantly described herein.

From the above two embodiments, the present invention provides a keyboard device with a luminous key. The light-emitting element of the luminous key is encapsulated by the opaque seal structure and the transparent seal structure, so that the light-emitting element is protected. In addition, the use of the opaque seal structure can reduce the possibility of scattering the light beams that are emitted by the light-emitting element, so that the illuminating efficacy of the luminous key is enhanced. Moreover, since the light shade is exempted from the keyboard device of the present invention, the problem of detaching the light shade will be eliminated. Moreover, according to the present invention, the opaque seal structure and the transparent seal structure have small volume. For example, the total height of the opaque seal structure and the transparent seal structure is about 0.55mm. When the luminous key is depressed by the user, the downward movement of the keycap will not be in contact with the opaque seal structure. In comparison with the conventional keyboard with the luminous keyboard, the operating feel of the keyboard device of the present invention is not deteriorated.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A keyboard device, comprising:
a membrane switch circuit member, wherein when said membrane switch circuit member is triggered, a luminous key signal is generated;
at least one luminous key disposed on said membrane switch circuit member, wherein when said at least one luminous key is depressed, said membrane switch circuit member is triggered, wherein said at least one luminous key has a light-transmissible zone; and
at least one light-emitting element electrically connected with said membrane switch circuit member and disposed under said light-transmissible zone, wherein said at least one light-emitting element emits a light beam in response to said luminous key signal, wherein a light-emitting region of said at least one light-emitting element is encapsulated by a transparent seal structure, and said transparent seal structure is surrounded by an opaque seal structure, so that a light-outputting region of said transparent seal structure is exposed outside said opaque seal structure, wherein said light beam is emitted by said light-emitting region, transmitted through said transparent seal structure, and directed to said light-transmissible zone through said light-outputting region.

2. The keyboard device according to claim 1, wherein said transparent seal structure is surrounded by an opaque seal structure, and a top surface of said transparent seal structure is partially sheltered by said opaque seal structure, so that a light-outputting region at said top surface of said transparent seal structure is exposed outside said opaque seal structure, wherein said light beam is blocked by said opaque seal structure, so that a possibility of scattering said light beam is reduced.

3. The keyboard device according to claim 1, wherein said transparent seal structure is made of transparent epoxy resin, and said opaque seal structure is made of opaque epoxy resin, wherein said opaque epoxy resin is produced by mixing transparent epoxy resin with a dying agent.

4. The keyboard device according to claim 1, wherein said transparent seal structure further contains phosphor powder, and said phosphor powder is distributed within said transparent seal structure, so that said transparent seal structure has a first color, wherein if said light beam has a second color, said light beam outputted from said transparent seal structure has a third color, wherein said third color is a mixed color of said first color and said second color.

5. The keyboard device according to claim 1, wherein after said opaque seal structure is disposed on said at least one light-emitting element, said transparent seal structure is filled into a space between said opaque seal structure and said at least one light-emitting element, so that said at least one light-emitting element is encapsulated by said transparent seal structure.

6. The keyboard device according to claim 1, further comprising a non-luminous key, which is disposed on said membrane switch circuit member, wherein when said membrane switch circuit member is depressed, a corresponding non-luminous key signal is generated.

7. The keyboard device according to claim 6, wherein said membrane switch circuit member comprises:
an upper wiring board having at least one upper contact corresponding to said at least one luminous key or said at least one non-luminous key;
a partition plate disposed under said upper wiring board, and having at least one perforation corresponding to said at least one upper contact, wherein when said membrane switch circuit member is depressed, said at least one upper contact is inserted into said at least one perforation; and
a lower wiring board disposed under said partition plate, and having at least one lower contact corresponding to said at least one upper contact, wherein said at least one upper contact, said at least one perforation and said at least one lower contact are collectively defined at least one membrane switch, wherein when said membrane switch circuit member is depressed, said at least one lower contact and said at least one upper contact are contacted with each other, so that said luminous key signal or said non-luminous key signal is generated.

8. The keyboard device according to claim 6, further comprising a bottom plate for supporting said at least one non-luminous key and said at least one luminous key, wherein said at least one luminous key comprises:
a keycap exposed to a top surface of said keyboard device, wherein said light-transmissible zone is included in said keycap;
a scissors-type connecting element arranged between said bottom plate and said keycap for connecting said bottom plate and said keycap, and allowing said keycap to be moved upwardly and downwardly relative to said bottom plate; and
an elastic element arranged between said membrane switch circuit member and said keycap, wherein when said keycap is depressed, said elastic element is compressed and sustained against said membrane switch circuit module, so that said membrane switch circuit member generates said luminous key signal, wherein when a depressing force exerted on said key is eliminated, an elastic force provided by said elastic element is acted on said keycap, so that said keycap is returned to an original position.

9. The keyboard device according to claim 6, further comprising a base for supporting said at least one non-luminous key and said at least one luminous key, wherein said at least one luminous key comprises:
a keycap exposed to a top surface of said keyboard device, wherein said light-transmissible zone is included in said keycap;
a key housing arranged between said base and said keycap for supporting said keycap; and
an elastic element penetrated through said key housing and arranged between said membrane switch circuit member and said keycap, wherein when said keycap is depressed, said elastic element is compressed and sustained against said membrane switch circuit module, so that said membrane switch circuit member generates said luminous key signal, wherein when a depressing force exerted on said key is eliminated, an elastic force provided by said elastic element is acted on said keycap, so that said keycap is returned to an original position.

10. The keyboard device according to claim 1, wherein said at least one light-emitting element further comprises:
a light-emitting circuit board electrically connected with said membrane switch circuit member; and
a light-emitting chip disposed on said light-emitting circuit board and electrically connected with said light-emitting circuit board for generating said light beam, wherein said at least one light-emitting element is a top-view light emitting diode.
